(19) United States
(12) Patent Application Publication
(10) Pub. No.: US 2010/0063840 A1
(43) Pub. Date: Mar. 11, 2010

(54) System and method for managing coordination of collected patient data in an automated patient management system

(76) Inventors: Kenneth P. Hoyme, Plymouth, MN (US); Howard D. Simms, Shoreview, MN (US); David C. Johnson, Inver Grove Heights, MN (US); Muralidharan Srivathsa, Shoreview, MN (US)

Correspondence Address: PAULY, DEVRIES SMITH & DEFFNER, L.L.C., PLAZA VII- SUITE 3000, 45 SOUTH SEVENTH STREET, MINNEAPOLIS, MN, 55402-1630, US

(21) Appl. No.: 11/121,593

(22) Filed: May 3, 2005

(51) Int. Cl. G06Q 50/00; G06Q 10/00

(52) U.S. Cl. 705/3

(57) ABSTRACT

A system and method for managing coordination of collected patient data in an automated patient management system is presented. One or more displays of patient data are defined. The patient data is collected from one or more patient data sources operating on a remotely managed patient and selected from at least one of a physiological sensor and a therapy delivery device. One or more controls of patient data collection to specify types of patient data to be collected and periodicities of the patient data collection in relation to the patient data displays are defined. The patient data displays and patient data controls in relation to the data collection of a plurality of patient data types and patient data collection periodicities are coordinated.

### FIELD OF THE INVENTION

The present invention relates in general to automated patient management and, specifically, to a system and method for managing coordination of collected patient data in an automated patient management system.

### BACKGROUND OF THE INVENTION

A patient's medical history is a key source of information used in modern clinical practice. A medical history is used to collect information obtained directly from the patient and data gathered from other sources in-clinic, as well as from interrogations of medical devices and sensors, for example, implantable medical devices (IMDs), such as pacemakers or defibrillators. A medical history documents the patient's physical status and physiological, social, and sexual functions and provides a basis for diagnosis, treatment, care, and follow-up. The medical history often includes written and transcribed notes supplemented by laboratory and testing documentation and medical device and sensor telemetry data. Medical histories are reviewed by healthcare providers prior to patient interviews and to provide referrals or consultations to colleagues and other authorized health care professionals.

Increasingly, patient medical histories are being maintained in digital form on electronic medical record (EMR) systems, which maintain a set of patient medical records collectively storing patient information, including medical histories, as well as appointment, billing, insurance, and other patient data. Due to patient privacy concerns, such as the Health Insurance Portability and Accountability Act (HIPAA) and the European Privacy Directive (EPD) mandates, as well as pragmatic considerations, EMR systems are generally intended only for in-clinic or in-hospital use by clinicians that are formally affiliated with the organization or entity responsible for the EMR system.

As an adjunct to EMR systems, alternative data collection methods for interrogations of medical devices and sensors, such as transtelephonic monitoring, can enable a healthcare provider to provide limited remote patient management on a more frequent, often monthly, basis. In addition, dedicated remote patient management devices, such as repeaters, have enabled healthcare providers to remotely perform follow-up monitoring on a daily basis using a data communications network, such as the Internet. Due to concerns similar to those relating to EMR systems, the patient data obtained through these data collection methods are also generally intended only for use by clinicians that are formally affiliated with the clinic, hospital or organization. Moreover, the devices used to interrogate the medical devices and sensors are generally configured to operate as stand-alone systems that operate independently from other interrogation devices and records systems.

Consequently, cooperative collection of and access to patient information by authorized, but non-affiliated clinicians, is not available due to the artificial constraints of formal affiliation and for a lack of controls for facilitating the coordination of the types of patient data needed and the intervals at which such patient data is collected by multiple, cooperating clinicians.

Therefore, there is a need for a cooperative approach to providing automated patient management of remote patients for a plurality of clinicians that can have differing patient data type and collection interval needs. Preferably, such an approach would allow groups of clinicians to independently or cooperatively define flexible patient data display and collection requirements.

### SUMMARY OF THE INVENTION

A system and method includes accommodating the needs of a plurality of clinicians, such as individual physicians and organizations, by providing clinician-specific display, clinician-specific control, and clinician coordination of collected patient data. Patient data is collected from patient data sources, including implantable and external medical devices and sensors. A set of individual displays of the patient data are provided for presenting various views of the patient data, formatted, for instance, for viewing as Web pages, in hard copy, and in other forms of physical media. A set of controls are also provided to specify the types of patient data that are to be collected and the associated periodicities with which those types of patient data will be collected. Finally, different clinician needs for patient data display and collection are coordinated where possible or practicable, for example, by reconciling and merging patient data collection schedules.

One embodiment provides a system and method for managing coordination of collected patient data in an automated patient management system. One or more displays of patient data are defined. The patient data is collected from one or more patient data sources operating on a remotely managed patient and selected from at least one of a physiological sensor and a therapy delivery device. One or more controls of patient data collection to specify types of patient data to be collected and periodicities of the patient data collection in relation to the patient data displays are defined. The patient data displays and patient data controls in relation to the data collection of a plurality of patient data types and patient data collection periodicities are coordinated.

Still other embodiments of the present invention will become readily apparent to those skilled in the art from the following detailed description, wherein are described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. Accordingly, the drawings and detailed description are to be regarded as illustrative in nature and not as restrictive.

### BRIEF DESCRIPTION OF THE DRAWINGS

FIG. 1 is a functional block diagram showing, by way of example, an automated patient management environment, in accordance with one embodiment.

FIG. 2 is a functional block diagram showing data collection in the environment of FIG. 1.

FIG. 3 is a process flow diagram showing collected patient data coordination in the environment of FIG. 1.

FIG. 4 is a data flow diagram showing collected patient data display settings for use in the environment of FIG. 1.

FIG. 5 is a screen diagram showing, by way of example, a patient data display generated by the server of FIG. 1.

FIG. 6 is a functional block diagram showing, by way of example, hierarchically structured patient data displays provided in the environment of FIG. 1, in accordance with a further embodiment.

FIG. 7 is a functional block diagram showing a server for managing coordination of collected patient data in an automated patient management system for use in the environment of FIG. 1.

### DETAILED DESCRIPTION

### Automated Patient Management Environment

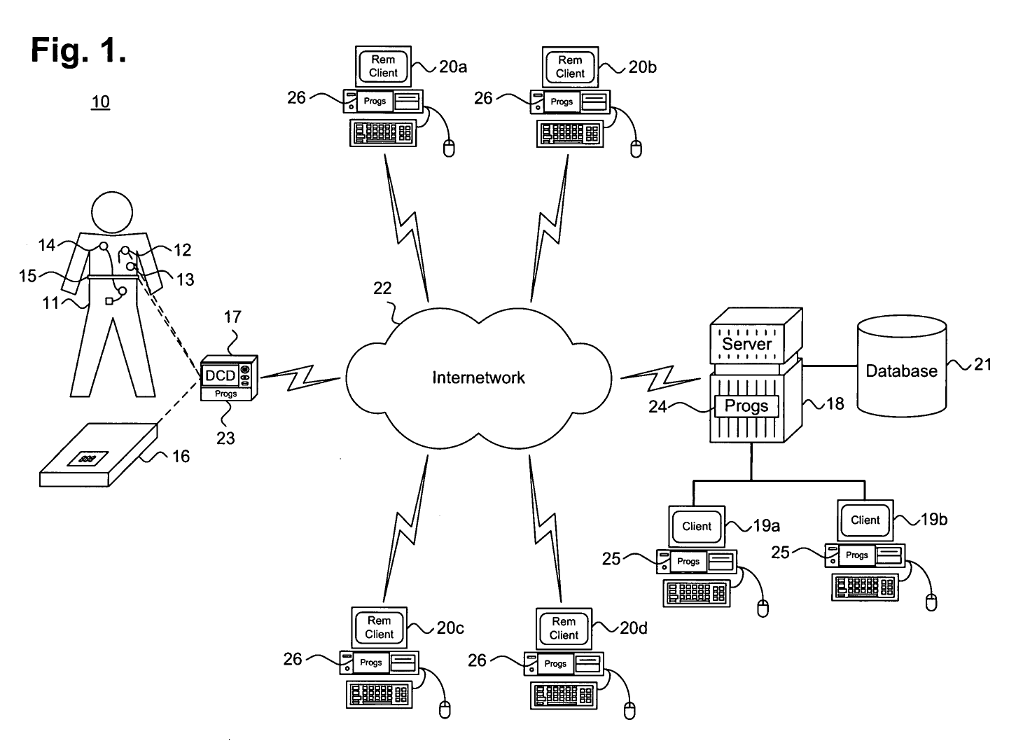

Automated patient management encompasses a range of activities, including remote patient management and automatic diagnosis of patient health, such as described in commonly-assigned U.S. Patent application Pub. No. US 2004/0103001, pending, published May 27, 2004, the disclosure of which is incorporated by reference. Such activities can be performed proximal to a patient, such as in the patient's home or office, through a centralized server, such as in a hospital, clinic or physician's office, or through a remote workstation, such as a secure wireless mobile computing device. FIG. 1 is a functional block diagram showing, by way of example, an automated patient management environment 10, in accordance with one embodiment. An individual patient 11 is remotely managed through one or more data collection devices 17, for example, such as described in commonly-assigned U.S. Patent application, entitled, “System and Method for Managing Alert Notifications in an Automated Patient Management System,” Ser. No. ______, filed May 3, 2005, pending, the disclosure of which is incorporated by reference. Each data collection device 17 is interconnected remotely over an internetwork 22, such as the Internet to a centralized server 18. The internetwork 22 can provide both conventional wired and wireless interconnectivity. In one embodiment, the internetwork 22 is based on the Transmission Control Protocol/Internet Protocol (TCP/IP) network communication specification, although other types or combinations of networking implementations are possible. Similarly, other network topologies and arrangements are possible.

Each data collection device 17 is uniquely assigned to an individual patient 11 to provide a localized and network-accessible interface to one or more patient data sources 12-16, either through direct means, such as wired connectivity, or through indirect means, such as inductive, radio frequency or wireless telemetry based on, for example, “strong” Bluetooth or IEEE 802.11 wireless fidelity “WiFi” interfacing standards. Other configurations and combinations of patient data source interfacing are possible.

Patient data includes physiological measures, which can be quantitative or qualitative, parametric data regarding the status and operational characteristics of the patient data source itself, and environmental parameters, such as the temperature or time of day. Other types of patient data are possible. The patient data sources collect and forward the patient data either as a primary or supplemental function. Patient data sources include, by way of example, medical devices that deliver or provide therapy to the patient 11, sensors that sense physiological data in relation to the patient 11, and measurement devices that measure environmental parameters occurring independent of the patient 11. Each patient data source can generate one or more types of patient data and can incorporate one or more components for delivering therapy, sensing physiological data and measuring environmental parameters. In a further embodiment, data values could be entered by a patient 11 directly into a patient data source. For example, answers to health questions could be input into a measurement device that includes interactive user interfacing means, such as a keyboard and display or microphone and speaker. Such patient-provided data values could also be collected as patient information. Additionally, measurement devices are frequently incorporated into medical devices and sensors. Medical devices include implantable medical devices (IMDs) 12, such as pacemakers, implantable cardiac defibrillators (ICDs), drug pumps, and neuro-stimulators, and external medical devices (EMDs) 14, such as automatic external defibrillators (AEDs). Sensors include implantable sensors 13, such as implantable heart and respiratory monitors and implantable diagnostic multi-sensor non-therapeutic devices, and external sensors 15, 16, such as Holter monitors, weight scales, and blood pressure cuffs. Other types of medical, sensing, and measuring devices, both implantable and external, are possible.

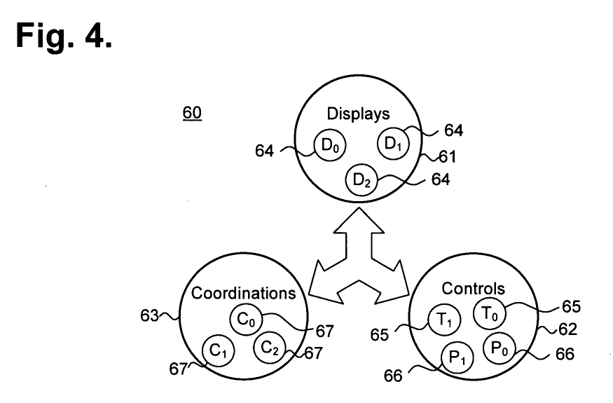

The data collection device 17 collects and temporarily stores patient data from the patient data sources 12-16 for periodic upload over the internetwork 22 to the server 18 and storage in a database 21. Patient data collection can be defined to be initiated by either the patient collection device 17 or by one or more of the patient data sources 12-16. The collected patient data can also be accessed and analyzed by one or more locally-configured clients 19a-b or one or more remote clients 20a-d securely-interconnected over the internetwork 22, as further described below with reference to FIGS. 3 and 4. Access to the collected patient data includes a capability to provide flexible display and control that is securely and intelligently coordinated between a plurality of clinicians, such as physicians, nurses, or qualified medical specialists. In a further embodiment, the clients 19a-b and remote clients 20a-d can be used, for example, by clinicians to select and prioritize patients for health care provisioning, such as described in commonly-assigned U.S. Patent application, entitled, “System and Method for Managing Patient Triage in an Automated Patient Management System,” Ser. No. ______, filed May 3, 2005, pending, the disclosure of which is incorporated by reference. Although described herein with reference to clinicians, the entire discussion applies equally to organizations, including hospitals, clinics, and laboratories, and other individuals or interests, such as researchers, scientists, universities, and governmental agencies, seeking access to the patient data.

The collected patient data can also be evaluated for the occurrence of one or more conditions, such as described in related, commonly-owned U.S. Pat. No. 6,336,903, to Bardy, issued Jan. 8, 2002; U.S. Pat. No. 6,368,284, to Bardy, issued Apr. 9, 2002; U.S. Pat. No. 6,398,728, to Bardy, issued Jun. 2, 2002; U.S. Pat. No. 6,411,840, to Bardy, issued Jun. 25, 2002; and U.S. Pat. No. 6,440,066, to Bardy, issued Aug. 27, 2002, the disclosures of which are incorporated by reference. Patient data evaluation can be defined to be performed by either the patient collection device 17 or the server 18.

Finally, conditions occurring in the collected patient data can trigger one or more alert notifications that provide external indicators of the condition occurrences. Alert notification can be defined to be performed by either the server 18, patient collection device 17, or one or more other devices either operating as part of or as an adjunct to the internetwork 22.

In a further embodiment, patient data is safeguarded against unauthorized disclosure to third parties, including during collection, assembly, evaluation, transmission, and storage, to protect patient privacy and comply with recently enacted medical information privacy laws, such as the Health Insurance Portability and Accountability Act (HIPAA) and the European Privacy Directive. At a minimum, patient health information that identifies a particular individual with health- and medical-related information is treated as protectable, although other types of sensitive information in addition to or in lieu of specific patient health information could also be protectable.

Preferably, the server 18 is a server-grade computing platform configured as a uni-, multi- or distributed processing system, and the clients 19a-b and remote clients 20a-d are general-purpose computing workstations, such as a personal desktop or notebook computer. In addition, the data collection device 17, server 18, clients 19a-b, and remote clients 20a-d are programmable computing devices that respectively execute set of software programs 23, 24, 25, 26 and include components conventionally found in computing device, such as, for example, a central processing unit (CPU), memory, network interface, persistent storage, and various components for interconnecting these components.

### Data Collection

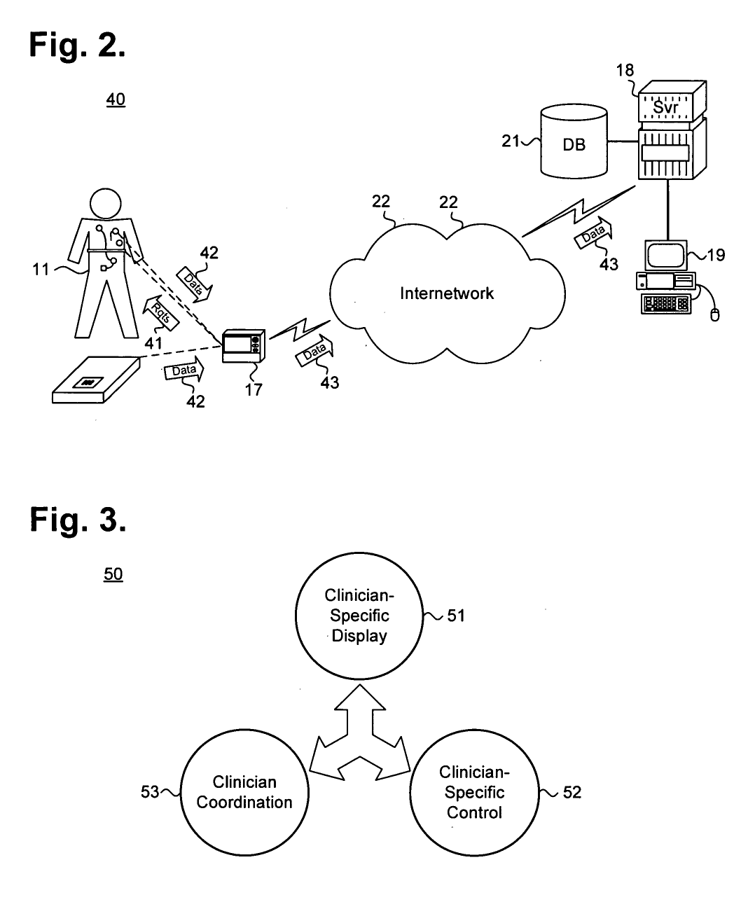

Automated patient management allows a potentially enormous amount of patient data to be generated through substantially continuous monitoring and the amount and frequency of such patient data generation can be controlled through data collection management. FIG. 2 is a functional block diagram showing data collection 40 in the environment 10 of FIG. 1. The data collection process reflects the dichotomy of data collection device-versus patient data source-initiated data collection.

Patient data sources that operate autonomously from the patient are generally able to record patient data at any time and under any conditions. However, the recorded patient data accumulated by the patient data source must be periodically uploaded to free limited onboard storage and to facilitate processing and analysis. In one embodiment, schedules can be associated with a subset of the interfaced patient data sources to provide data collection device-initiated patient data collection. Alternatively, a schedule can also be provided to initiate prompted retrieval of patient data by the remotely managed patient. For example, the patient might be instructed to complete a measurement, such as by using an inductive wand on a legacy repeater to interrogate an implanted medical device or sensor or to take a weight or blood pressure reading. The patient could be sent a message or an indicator light or signal on the data collection device 17 could be turned on as a reminder. Other forms of prompted data retrieval are possible. A schedule might be appropriate for a patient data source, such as an implanted cardiac pulse generator, where patient data may be collected on a daily or weekly basis. The schedule can either be built into the data collection device 17 or can be provided by the server 18, based on configuration options selected by the clinician. The data collection device attempts to collect patient data at a scheduled interval by sending requests 41 to the associated patient data source, which returns patient data 42. In the absence of expected patient data receipt, the data collection device 17 can implement a follow-up scheme with the patient data source, if possible, to investigate delayed or missing patient data, or by sending a message or other communication to the patient 11, clinician or authorized third party as a compliance notification.

Scheduled data collection might not be appropriate for all patient data sources 12-16. For example, a battery powered weight scale that uses radio frequency telemetry to communicate with a data collection device 17 would normally be turned off to extend battery life. Ordinarily, such a device would communicate with the data collection device 17 only after use by the patient and would otherwise be in a standby or sleep state. Such devices frequently operate in a send-only mode and may therefore be incapable of receiving incoming messages. The patient data source asynchronously sends patient data 42 to the data collection device 17 to provide patient data source-initiated patient data collection. In one embodiment, frequencies can be associated with a subset of the interfaced patient data sources to allow the data collection device 17 to track or limit the receipt of patient data. In the absence of expected patient data receipt, the data collection device 17 can implement a follow-up scheme with the patient data source, if possible, to investigate delayed or missing patient data, or by sending a message or other communication to the patient 11, clinician or authorized third party as a compliance notification.

Finally, collected patient data 43 is uploaded by the data collection device 17 to the server 18 either upon receipt or, in a further embodiment, after a delay to allow patient data 42 from multiple patient data sources to accumulate. The server 18 stores the uploaded patient data 43 in the database 21 as collected patient data.

### Collected Patient Data Coordination

Each clinician may have different needs for the display and collection of patient data. For example, an cardiologist might need to review different arrangements of patient data than an electrophysiologist. Moreover, both the cardiologist and electrophysiologist might have different data collection needs in terms of timing and the types of information required. As a result, clinician data display and collection needs must be coordinated. FIG. 3 is a process flow diagram showing collected patient data coordination 50 in the environment 10 of FIG. 1. The process involves balancing and coordinating individual clinician needs, while ensuring efficient patient data retrieval and processing.

In one embodiment, accommodations for clinician-specific display, clinician-specific control, and clinician coordination requirements are provided using the server 18. Generally, patient data is collected from patient data sources 12-16 by data collection devices 17 for eventual upload to the server 18. Once received, the server 18 stores the collected patient data into the database 21 to be made available for clinician use. In a further embodiment, the collected patient data is also analyzed by the server 18 to determine patient wellness, device status, and similar information.

Clinician-specific display requirements 51 provide customizable views of the patient data to meet particular clinician display needs. To accommodate these needs, a set of individual displays of the patient data are provided. Each display defines the presentation format and form of physical media used to display the patient data. In one embodiment, clinicians are provided with summary patient information presented on a single viewable Web page and detailed patient information presented on separate, linked-in viewable Web pages. Additionally, the clinician can customize the displays set by creating new or by modifying existing displays based on individual preferences. Other clinician-specific displays are possible.

Clinician-specific control requirements 52 specify the types of patient data that are to be collected and the associated periodicities with which those types of patient data will be collected. To accommodate these needs, a set of controls are provided. Each control defines the types of patient data required and the periodicity with which the patient data will be collected from an associated patient data source 12-16. For example, a schedule can be defined to provide automated retrieval of patient data. Alternatively, a frequency can be defined to facilitate on-demand retrieval of patient data, where the frequency indicates a maximum allowable delay for expected patient data receipt. Unlike displays, which generally can be shared by multiple clinicians without interference or conflict, controls typically capture clinical aspects of particular interest to an individual clinician. For instance, a cardiologist following a patient with a history of congestive heart failure might need to collect certain types of physiological measurements taken at precise intervals, yet such patient data may be of lesser interest to other clinicians. In a further embodiment, clinician-specific controls can be defined for a subset of authorized clinicians, which can include a just single clinician or multiple clinicians. Other types of clinician-specific controls are possible.

Finally, clinician coordination requirements 53 reconcile competing data display and collection needs. For example, the data collection periodicity of one clinician might exceed the periodicity of another clinician, which would require that the competing data collection needs be reviewed and, if possible or practicable, merged. To accommodate these needs, clinicians are notified when their data display or collection requirements are in conflict with the needs of other clinicians. If the conflicting needs cannot be reconciled, either through automatic or manual means, the clinicians can be notified, such as when patient data is received ahead of schedule due to the scheduling settings of another clinician. In a further embodiment, the data collection requirements for a plurality of clinicians can be merged to minimize communications overhead and to efficiently aggregate those data collection needs occurring within proximal time spans. Other types of clinician coordination are possible.

### Collected Patient Data Display Settings

Clinician data display, collection and coordination needs are addressed through a set of display settings maintained by the server 18. FIG. 4 is a data flow diagram showing collected patient data display settings 60 for use in the environment 10 of FIG. 1. The settings specify displays 61, controls 62, and coordinations 63 that respectively accommodate clinician-specific display, clinician-specific control, and clinician coordination requirements.

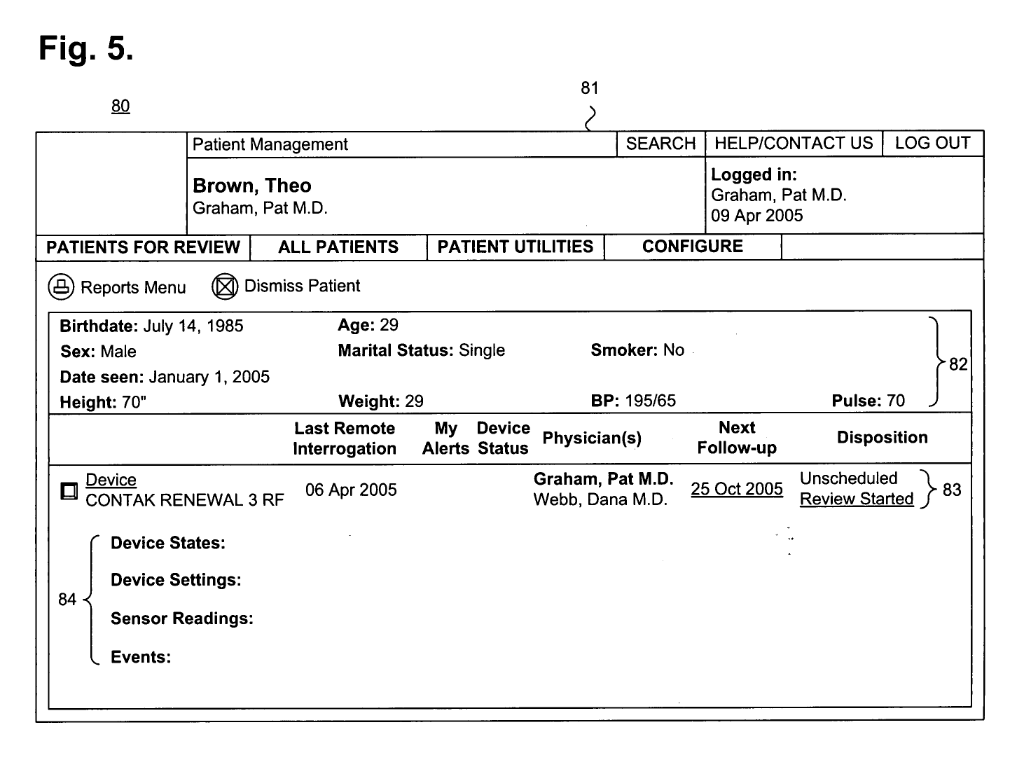

In one embodiment, a set of individual displays 61 of the patient data are provided for presenting various views of the patient data, formatted, for instance, for viewing as Web pages, in hard copy, and in other forms of physical media. Individual customizable displays 64 are provided as viewable presentations of the patient data and other information to meet specific clinician needs, such as further described below with reference to FIG. 5. Other displays are possible.

In a further embodiment, the displays 61 can be customized to map to the specific needs of a particular clinician or interest, for example, by medical subspecialty, practice affiliation, organizational affiliation, referring role, following role, or billing entity. Other types of mappings are possible. In addition, absent express permission, clinicians are not ordinarily allowed to access other clinician displays 64 to safeguard patient privacy and to comply with applicable medical information privacy laws. However, special permissions and exceptions to the displays 61 could also be provided to allow authorized access.

In a still further embodiment, access control to the displays 61 could be provided as a hierarchy of permissions. For instance, where the collected patient data is maintained in an electronic medical records (EMR) system or similar secure data repository, access to the displays 61 could initially be limited to only those clinicians formally affiliated with the organization or entity responsible for the EMR system. Additional layers of permissions can be added as other clinicians are authorized access. Other forms of access control are possible.

A set of controls 62 are also provided to specify the types of patient data 65 that are to be collected and the associated periodicities 66 with which those types of patient data will be collected. Patient data types 65 include physiological measures, parametric data, and environmental parameters. Other patient data types are possible. Periodicities 66 include schedules and frequencies that respectively specify requested and on-demand data collection. Other periodicities are also possible.

Finally, a set of coordinations 63 are provided to coordinate the different needs of the clinicians, for example, by reconciling and merging patient data collection where possible or practicable. Individual coordinated needs are recorded as coordinations 67. Conflicts between competing data collection needs can be resolved by aggregating data collection needs, where feasible, for instance, where separate schedules for the same patient data source can be safely merged into a single schedule. Alternatively, a clinician can filter out patient data that is being collected more frequently than required, where the needs of the competing clinician cannot be reconciled. Other coordinations are possible.

### Sample User Interface

In one embodiment, clinician-customizable displays are provided as viewable pages in a Web-based format, although other types of formats, as well as physical media, are possible. FIG. 5 is a screen diagram 80 showing, by way of example, a patient data display 81, generated by the server 18 of FIG. 1. The patient data display 81 can be viewed via a Web browser executing on the clients 19a-b, remote clients 20a-d, or other compatible computing systems. Moreover, although described with reference to a viewable Web page, patient data displays can also include other formats and physical media. The patient data display 81 includes both patient-identifying information and statistics 82, clinician-specific patient data 83, and device-related parametric and event data 84. Other types of information can also be included.

In a further embodiment, each clinician is provided with a set of summary patient information that is displayed on a single viewable page, with more detailed patient information that is displayed on separately viewable pages navigable from the summary page. By default, the contents of the summary page and detailed pages are chosen to be specific to the medical needs of generic classes of clinicians, such as cardiologists, but can also be customized to suit the specific needs of a particular clinician or interest, for example, by medical subspecialty, practice affiliation, organizational affiliation, referring role, following role, or billing entity. In addition, special permissions and exceptions could also be provided. Thus, an authorized clinician can choose from a set of default page types or can create a page type based on their personal preferences. For example, an electrophysiologist responsible for the management of an implanted defibrillator would see summary information that would provide information on the device status, such as battery, leads, and so forth, plus information on past arrhythmias and current therapy settings. Detailed pages would allow the electrophysiologist to viewing settings, histograms, trends, and captured electrocardiograms in greater detail. Similarly, a heart failure specialist would have a different interest in the medical data received from the same patient. The summary information would include measurements and trends in weight and blood pressure, medication, and information from the implanted device that could give an insight into their heart failure status, such as activity, heart rate variability, and percent pacing. Finally, a specialist in diabetes would have still other interests in the medical data, as would an internist or sleep specialist. The common data gathered from the implanted and external medical devices and sensors can be organized, wherein the information needed by a clinician to monitor the medical conditions in which they have an interest are available in summary form with detailed information provided in detailed pages. Information in which they are not interest or in which they lack a sufficient background to interpret need not be displayed and can be filtered or screened.

### Hierarchically Structured Patient Data Displays

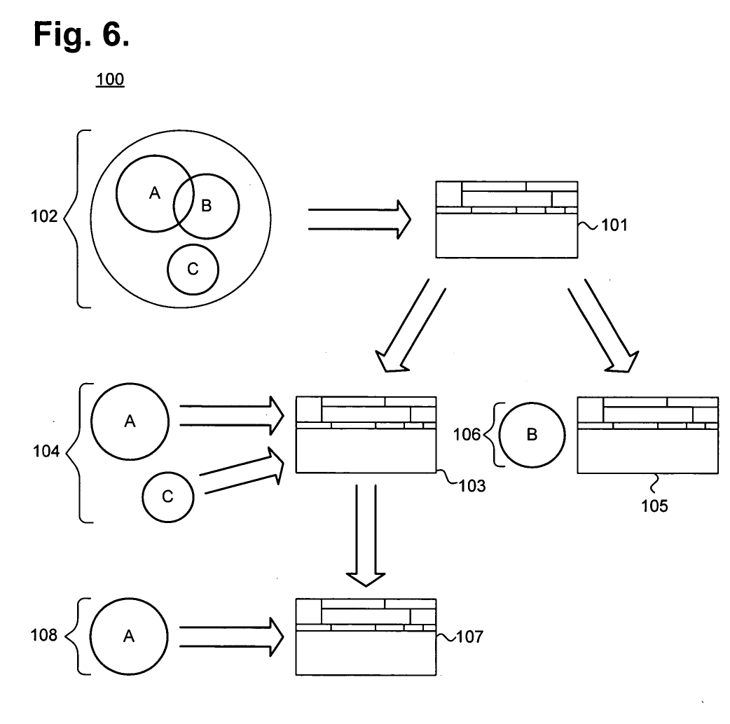

In one embodiment, patient data displays are defined on an individual clinician basis. In a further embodiment, the displays can be structured in a hierarchy of related displays that enable management of the overall flow of patient data between a group of cooperating clinicians. FIG. 6 is a functional block diagram showing, by way of example, hierarchically structured patient data displays 100 provided in the environment 10 of FIG. 1, in accordance with a further embodiment. Although described with reference to a set of viewable Web pages, hierarchical structurings of heterogeneous formats and physical media are possible, such as a combination of viewable Web pages, hardcopies, and files.

The hierarchical structuring includes a set of levels 102, 104, 108. The levels reflect degrees of separation from a topmost, root patient data display 101, which includes a complete set of patient data, consisting of patient data A, B and C, for use by a managing clinician. The complete set of patient data can be logically divided into two subsets respectively including patient data A and C and patient data B. These subsets of patient data can respectively be viewed on child patient data displays 103 and 105. Similarly, the partial subset of patient data A B can be further logically divided into a subset that only includes patient data A. This subset of patient data can be viewed on grandchild patient data display 107. Thus, through the hierarchical structuring, access to and routing of the patient data can be managed for a larger group of clinicians. Other arrangements and organizations cooperative patient data sharing are possible.

### Server

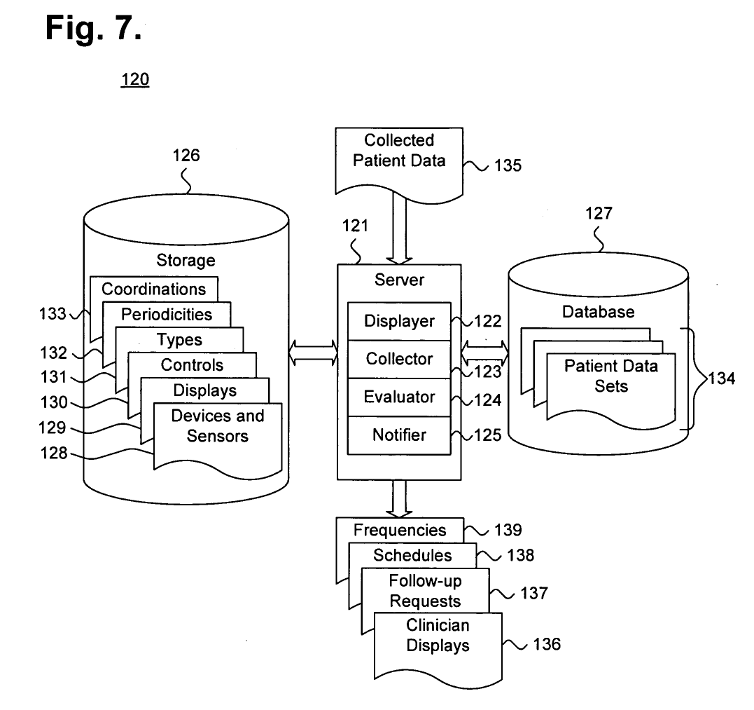

The server acts as the central hub for coordinated patient data collection and display. FIG. 7 is a functional block diagram 120 showing a server 121 for managing coordination of collected patient data in an automated patient management system for use in the environment 10 of FIG. 1. The server 121 includes storage 126 and database 127 and can be configured to coordinate the displaying of patient data between a plurality of clients 19a-b, remote clients 20a-d, and other compatible computing systems. Other server functions are possible.

At a minimum, the server 121 includes a displayer 122. The displayer 122 provides collected and processed patient data through a set of displays 129 presenting various views of the patient data. The displayer 122 provides a set of controls 130 that specify the types of patient data 131 that are to be collected and the associated periodicities 132 with which those types of patient data will be collected. Finally, the displayer 122 provides a set of coordinations 133 that record reconciliations of different clinician needs for patient data collection and display where possible or practicable.

In a further embodiment, the server 121 further includes a collector 123, evaluator 124, and notifier 125. The collector 123 maintains a list of devices and sensors 128 for all patient data sources 12-16, which can be used by a clinician to create schedules 138 and maximum frequencies 139 to manage the collection of patient data by interfaced data collection devices. The collector 123 collects patient data 135 received from the data collection devices, which are stored as patient data sets 134 in the database 127. The collector 123 can execute a follow-up scheme, for example, by sending follow-up requests 137 to patient data sources, if possible, that have not sent expected collected patient data, or by sending a message or other communication to the patient 11, clinician or authorized third party as a compliance notification.

The evaluator 124 evaluates the collected patient data 135 against a complete set of alert conditions. One or more triggers are associated with the alert conditions and occurrences of alert condition set off the associated triggers. The same alert conditions can be evaluated by both the server 121 and one or more of the data collection devices.

The notifier 125 provides alert notifications. Alert notifications are assigned to notification schemes that are executed upon the detection of an associated trigger. The notification schemes can be organized into one or more levels of alerts. By way of example, alert notifications 164 can include a Web page update, phone or pager call, E-mail, SMS, text or “Instant” message, as well as a message to the patient send through the data collection device 17 and simultaneous direct notification to emergency services and to the clinician. Other alert notifications are possible.

While the invention has been particularly shown and described as referenced to the embodiments thereof, those skilled in the art will understand that the foregoing and other changes in form and detail may be made therein without departing from the spirit and scope of the invention.

1. A system for managing coordination of collected patient data in an automated patient management system, comprising:
clinician-specific display requirements;
clinician-specific control requirements;
one or more displays of patient data on a server, wherein the patient data is collected from one or more patient data sources operating on a remotely managed patient and selected from at least one of a physiological sensor and a therapy delivery device, wherein the displays are based on the clinician-specific display requirements;
one or more controls of patient data collection on a server, wherein the controls are based on the clinician-specific control requirements and defined to specify types of patient data to be collected and periodicities of the patient data collection in relation to the patient data displays; and
a displayer on a server to coordinate the patient data displays and patient data controls in relation to the data collection of a plurality of patient data types and patient data collection periodicities.

2. A system according to claim 1, wherein the patient data displays are organized comprising at least one of:
a display scheme specified to comprise at least one of default and customized displays of the patient data;
a display scheme specified to comprise at least one of summary and detailed displays of the patient data;
display groups selected to collect patient data from at least one of medical subspecialty,
practice affiliation, organizational affiliation, referring role, following role, billing entity, special permissions, and exceptions;
a subset of the patient data selected through at least one of screen, filtering, and choosing; and
a display scheme specified to comprise hierarchically-structured patient data displays.

3. A system according to claim 1 ,wherein the patient data controls are specified comprising at least one of:
a schedule defined to be associated with at least one such patient data source to provide automated retrieval of the patient data;
a schedule defined to be associated with at least one such patient data source to provide prompted retrieval of the patient data by the remotely managed patient;
a frequency defined to be associated with at least one such patient data source to track on-demand retrieval of the patient data; and
a follow-up scheme defined to be associated with at least one such patient data source executable in an absence of expected patient data assembly;
and a follow-up scheme defined to be associated with at least one of the remotely managed patient, a patient-managing clinician, and an authorized third party executable in an absence of expected patient data collection.

4. A system according to claim 3, wherein conflicts in the patient data collection occurring within a same proximal time span are resolved.

5. A system according to claim 3, wherein conflicts between different schedules are resolved by merging the schedules.

6. A system according to claim 3, wherein conflicts between the different frequencies are resolved by merging the frequencies.

7. A system according to claim 1, wherein the definition of the patient data controls is limited to a subset of clinicians having access to the patient data.

8. A system according to claim 1, further comprising:
one or more triggers on a server defined for each such patient data control and associated with a condition occurring in relation to at least one such patient data evaluateable subsequent to collection; and
a notification scheme determined to be executable upon detection of at least one such trigger to provide an external indicator of the condition occurrence.

9. A system according to claim 1, further comprising:
access control on a server provided to the patient data displays as a hierarchy of permissions with one or more clinicians authorized access in each layer.

10. A system according to claim 1, further comprising:
a database on a server to store the collected patient data, wherein the stored collected patient data is included in relation to the patient data displays.

11. A system according to claim 1, wherein the patient data source comprises at least one of an implantable medical device, implantable diagnostic multi-sensor non-therapeutic device, external medical device, implantable sensor, and external sensor.

12. A method for managing coordination of collected patient data in an automated patient management system, comprising:
defining, on a server, one or more clinician-specific displays of patient data collected from one or more patient data sources operating on a remotely managed patient and selected from at least one of a physiological sensor and a therapy delivery device, wherein the one or more displays are based on clinician-specific display requirements;
defining, on a server, one or more clinician-specific controls of patient data collection to specify types of patient data to be collected and periodicities of the patient data collection in relation to the patient data displays, wherein the one or more controls are based on clinician- specific control requirements; and
coordinating, on a server, the patient data displays and patient data controls in relation to the data collection of a plurality of patient data types and patient data collection periodicities.

13. A method according to claim 12, further comprising:
organizing the patient data displays, comprising at least one of:
specifying a display scheme comprising at least one of default and customized displays of the patient data;
specifying a display scheme comprising at least one of summary and detailed displays of the patient data;
collecting the patient data into display groups selected from at least one of medical subspecialty, practice affiliation, organizational affiliation, referring role, following role, billing entity, special permissions, and exceptions;
selecting a subset of the patent data through at least one of screen, filtering, and choosing; and
specifying a display scheme comprising hierarchically-structured patient data displays.

14. A method according to claim 12, further comprising:
specifying the patient data controls, comprising at least one of:
defining a schedule associated with at least one such patient data source to provide automated retrieval of the patient data;
defining a schedule associated with at least one such patient data source to provide prompted retrieval of the patient data by the remotely managed patient;
defining a frequency associated with at least one such patient data source to track on-demand retrieval of the patient data; and
defining a follow-up scheme associated with at least one such patient data source executable in an absence of expected patient data assembly; and
defining a follow-up scheme associated with at least one of the remotely managed patient, a patient-managing clinician, and an authorized third party executable in an absence of expected patient data collection.

15. A method according to claim 14, further comprising: resolving conflicts in the patient data collection occurring within a same proximal time span.

16. A method according to claim 14, further comprising: resolving conflicts between different schedules by merging the schedules.

17. A method according to claim 14, further comprising: resolving conflicts between the different frequencies by merging the frequencies.

18. A method according to claim 12, further comprising: limiting the definition of the patient data controls to a subset of clinicians having access to the patient data.

19. A method according to claim 12, further comprising:
defining one or more triggers on a server for each such patient data control and associated with a condition occurring in relation to at least one such patient data evaluateable subsequent to collection; and
determining a notification scheme executable upon detection of at least one such trigger to provide an external indicator of the condition occurrence.

20. A method according to claim 12, further comprising:
providing access control on a server to the patient data displays as a hierarchy of permissions with one or more clinicians authorized access in each layer.

21. A method according to claim 12, further comprising:
storing the collected patient data on a server; and including the stored collected patient data in relation to the patient data displays.

22. A method according to claim 12, wherein the patient data source comprises at least one of an implantable medical device, implantable diagnostic multi-sensor non-therapeutic device, external medical device, implantable sensor, and external sensor.

23. A computer-readable storage medium for managing coordination of collected patient data in an automated patient management system comprising:
code for defining, on a server, one or more clinician-specific displays of patient data collected from one or more patient data sources operating on a remotely managed patient and selected from at least one of a physiological sensor and a therapy delivery device, wherein the one or more displays are based on clinician-specific display requirements;
code for defining, on a server, one or more clinician-specific controls of patient data collection to specify types of patient data to be collected and periodicities of the patient data collection in relation to the patient data displays, wherein the one or more controls are based on clinician-specific control requirements; and
code for coordinating, on a server, the patient data displays and patient data controls in relation to the data collection of a plurality of patient data types and patient data collection periodicities.

24. (canceled)
